(19) United States
(12) Patent Application Publication
(10) Pub. No.: US 2018/0264320 A1
(43) Pub. Date: Sep. 20, 2018

(54) SYSTEM AND METHOD FOR AUTOMATIC LOCATION DETECTION FOR WEARABLE SENSORS

(71) Applicant: Lumo BodyTech, Inc, Mountain View, CA (US)

(72) Inventors: Andrew Robert Chang, Sunnyvale, CA (US); Ray Franklin Cowan, Mountain View, CA (US); Daniel Le Ly, Mountain View, CA (US)

(21) Appl. No.: 15/920,365

(22) Filed: Mar. 13, 2018

Related U.S. Application Data
(60) Provisional application No. 62/471,112, filed on Mar. 14, 2017.

(51) Int. Cl. A63B 24/00; G06N 99/00

(52) U.S. Cl. CPC A63B 24/0062; A63B 24/0006; G06N 99/005; A63B 2220/12; A63B 2225/50; A63B 2220/836; A63B 2024/0009; A63B 2220/20; A63B 2220/73; A63B 2220/30; A63B 2220/18; A63B 2024/0012; A63B 2220/803

(57) ABSTRACT

A system and method for automatic location detection for wearable sensors can include collecting kinematic data from at least one kinematic activity sensor coupled to a user; generating a set of base kinematic metrics; assessing a set of sensor state discriminators and identifying a kinematic monitoring mode; and activating the kinematic monitoring mode at a kinematic activity sensor.

### CROSS-REFERENCE TO RELATED APPLICATIONS

This Application claims the benefit of U.S. Provisional Application No. 62/471,112, filed on 14 Mar. 2017, which is incorporated in its entirety by this reference.

### TECHNICAL FIELD

This invention relates generally to the field of activity monitoring, and more specifically to a new and useful system and method for automatic location detection for wearable sensors.

### BACKGROUND

Wearable sensor technologies are opening up new opportunities and applications across multiple areas including digital health, fitness and industrial operations. These sensor technologies are generating large volumes of new types of data, spurring a new revolution in data science and services.

However, while data is being generated at an unprecedented rate, current sensor technologies are not that ‘smart’ and often require many calibration steps to ensure data accuracy. Many times, users are required to be part of the calibration process or provide input. In some cases, a user is required to initiate a calibration, enter specific personal information or make sure the device is in the correct position and location on the body for a specified calibration process. Such usability issues in part contributes to limiting products to use only a single sensor since using multiple sensors only adds to the configuration steps.

In many cases, if a user is required to wear multiple sensor devices, the user needs to specify which sensor is worn on which part of the body. This can quickly become cumbersome to users who wear multiple sensors. This is important as movement analysis and applications are location specific, therefore the device needs to know the specific location it is sensing if it is to provide proper and correct output.

For instance, if a user was wearing a device on his hips and one on his gloves to measure the user's golf swing, the sensor on the glove may give erroneous, inaccurate or inappropriate data on the swing motion if it was programmed to analyze hip motion.

Thus, there is a need in the activity monitoring field to create a new and useful system and method for automatic location detection for wearable sensors. This invention provides such a new and useful system and method.

### BRIEF DESCRIPTION OF THE FIGURES

FIG. 1 is a schematic representation of a system of a preferred embodiment

FIG. 2 is a flowchart representation of a method of a preferred embodiment;

FIG. 3 is a flowchart representation of logic for assessing one exemplary set of sensor state discriminators;

FIG. 4 is a flowchart representation of logic for assessing a second exemplary set of sensor state discriminators;

FIG. 5 is a chart representing base metric data usable by a foot and upper body discriminator;

FIG. 6 is a chart representing base metric data usable by a right-left foot discriminator;

FIG. 7 is a chart representing base metric data usable by an arm and upper body discriminator;

FIG. 8 is a chart representing base metric data usable by a right-left arm discriminator;

FIG. 9 is a chart representing base metric data usable by a pelvic and chest discriminator;

FIG. 10 is a chart representing step impact magnitude;

FIG. 11 is a chart representing base metric data usable by a pelvis and clavicle discriminator; and

FIG. 12 is a chart representing base metric data usable by a foot and pelvis discriminator.

### DESCRIPTION OF THE EMBODIMENTS

The following description of the embodiments of the invention is not intended to limit the invention to these embodiments but rather to enable a person skilled in the art to make and use this invention.

### 1. Overview

A system and method for automatic location detection for wearable sensors functions to enable an activity monitoring platform to dynamically switch to context-appropriate monitoring modes. The system and method preferably functions to collect a set of biomechanical signals that are generated and customized to the location of a kinematic activity sensor and/or the current activity. The application and use of the generated biomechanical signals could additionally be customized for different monitoring modes.

The system and method preferably leverage a configuration mode that uses various base metrics to classify and/or validate sensor location. Here configuration mode describes the process of specifying the intended use of one or more sensor systems, such as sensor position and optionally current activity. A configuration mode may be applied during initialization of the system and method. The configuration mode may alternatively automatically activate when detecting a condition indicative of a location or activity change.

As an exemplary implementation, a kinematic activity sensor of the system and method may be worn in a variety of locations by a user such as on the foot, on the back in the pelvic region, on the upper body/clavicle area, or on an arm. The system and method can then work to automatically begin collecting gait-related biomechanical metrics, posture-related biomechanical metrics, and/or running-related biomechanical metrics depending on the location and/or current activity. The same kinematic activity sensor may be moved and worn in different locations, and the monitoring mode will preferably adapt automatically.

The system and method is preferably used with a dedicated kinematic activity sensor that can be worn or attached at various locations, but any suitable device that can provide kinematic activity sensing capabilities may alternatively be used (e.g., a smart watch that may be worn or attached at different locations).

As one potential benefit, the system and method may function to enable multifunctional activity sensors. An activity sensor can collect and act on different types of biomechanical data depending on the activity sensor's use. Additionally such multi-function usage is directed through physical use of the system. In some implementations, the user may be alleviated from using some user interface to configure usage to explicitly specify how an activity sensor is used.

As a related potential benefit, the system and method may reduce user error. The user interface to specify usage mode can become substantially transparent where the actual use of the sensor acts as the user input into how the system should operate.

As another potential benefit, the system and method may personalize monitoring mode detection and configuration to a particular user, which may enhance accuracy.

As another potential benefit, the system and method can accommodate multiple sensors. The multiple sensors can collaboratively be used to enhance configuration of the kinematic activity sensors. Each activity sensor may then generate biomechanical data depending on its individual configuration. Additionally, another potential benefit of the system and method may enable the activity sensors to collectively generate biomechanical data in a way partially optimized to the particular set of locations of the sensors. For example, activity sensors worn on the right foot, left foot, and pelvis may collect running biomechanical metrics in a manner different from activity sensors on the pelvis and clavicle. As a related potential benefit, various independent measurements from different positioned sensors may provide a more accurate estimate of a biomechanical property. For example, the pelvic sensor might measure ground contact using one method, while the foot-based sensor might measure the same ground contact time using a completely different method. By combining these independent sources, a biomechanical metric with greater accuracy than any individual sensor may be achieved by reducing the uncertainty.

The system and method are preferably used with an activity sensing device. A user may use such a system and method to track various activity metrics over the course of a day. This application may be customized to serve a general user interested in fitness and activity. The system and method may additionally or alternatively have particular use within the health/medical space. One type of sensor could be provided to a patient and used in a multitude of ways. A doctor could instruct a patient to wear a sensor in particular way to trigger the recording of customized biomechanical signals. The patient meanwhile may be spared performing any configuration, which may increase reliability of the system for health applications where the user may be not in a state to perform complicated tasks.

### 2. System

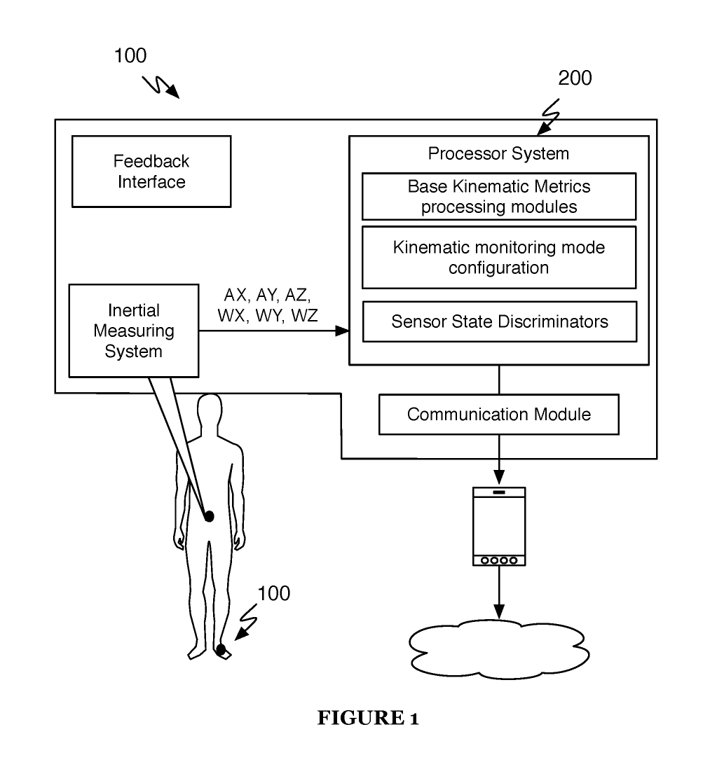

As shown in FIG. 1, a system for automatic location detection for wearable sensors of a preferred embodiment is an activity monitoring platform that may include at least one kinematic activity sensing device 100 and a processor system 200 configured to automatically calibrate the activity sensing device 100. The system functions to detect location of the activity sensing device 100 on the human body and/or detect activity state of a user. The system further functions to initiate operation of the activity sensing device 100 in an appropriate kinematic monitoring mode. The various kinematic monitoring modes may be used in collecting appropriate biomechanical signal data, controlling feedback, or initiating other suitable actions. The system may additionally include a connected user application and/or web service. A user application and web service can store user data across multiple system instantiations of different users. Location and activity identification models may be refined based on the data collected by the system.

The kinematic activity sensor device 100 (i.e., activity sensor) functions to collect kinematic data at some position coupled to the user that can at some point be transformed to one or more biomechanical signals. The kinematic activity sensor device 100 is a device that can be worn on the body, embedded into garments, belts and other equipment worn on the body. Depending on the specific application, the activity sensor device 100 can be worn on the waist, pelvis, upper body, shoes, thigh, arms, wrists or head.

If worn on the wrist or arm of a user, the device can be embedded into a watch, wrist band, elbow sleeve, or arm band. An additional device may be used and clipped on the other wrist or arm, or placed on the waist on the pelvis, or slipped into a pocket in the garment, embedded into the garment itself, back-brace, belt, hat, glasses or other products the user is wearing. The device can also be an adhesive patch worn on the skin. Other form factors can also clip onto the shoe or embedded into a pair of socks or the shoe itself.

The activity sensor device 100 may contain an inertial measurement unit (IMU) (an accelerometer, gyroscope, and/or magnetometer), an altimeter sensor, a processor, data storage, RAM, an EEPROM, user input elements (e.g., buttons, switches, capacitive sensors, touch screens, and the like), user output elements (e.g., status indicator lights, graphical display, speaker, audio jack, vibrational motor, and the like), communication components (e.g., Bluetooth LE, Zigbee, NFC, Wi-Fi, cellular data, and the like), and/or other suitable components.

The kinematic activity sensor device 100 may serve as a standalone device where operation is fully contained in one device. The kinematic activity sensor device 100 may additionally or alternatively communicate with at least one secondary system such as another kinematic activity sensor device 100, an application operating on a computing device; a remote activity data platform (e.g., a cloud-hosted platform); a secondary device (e.g., a mobile phone, a smart watch, computer, TV, augmented/virtual reality system, etc.); or any suitable external system.

In one variation, the system uses a multi-point sensing approach, wherein a set of activity sensors 100 measure motion at multiple points. The activity sensors 100 can be integrated into distinct devices wherein the system includes multiple communicatively coupled devices that can be mounted to different body locations. The points of measurement may be in the waist region, the upper leg, the lower leg, the foot, and/or any suitable location. Other points of measurement can include the upper body, the head, or portions of the arms. Various configurations of multi-point sensing can be used for sensing biomechanical signals. Different configurations may offer increased resolution, more robust sensing of one or more signals, and for detection of additional or alternative biomechanical signals. A foot activity monitor variation could be attached to or embedded in a shoe. A shank or thigh activity monitor could be strapped to the leg, embedded in an article of clothing, or positioned with any suitable approach. In a preferred implementation, the system includes a pelvic monitoring device that serves as a base sensor as many aspects of exercise activities can be interpreted from pelvic activity. A second monitoring device may be positioned on an arm or leg. The second monitoring device may additionally be expected to be movable such that it can be moved to different parts of the body depending on the activity.

An inertial measurement unit functions to measure multiple kinematic properties of an activity. An inertial measurement unit can include at least one accelerometer, gyroscope, magnetometer, and/or other suitable inertial sensor. The inertial measurement unit preferably includes a set of sensors aligned for detection of kinematic properties along three perpendicular axes. In one preferred variation, the inertial measurement unit is a 9-axis motion-tracking device that includes a 3-axis gyroscope, a 3-axis accelerometer, and a 3-axis magnetometer. The activity sensor device 100 can additionally include an integrated processor that provides sensor fusion. Sensor fusion can combine kinematic data from the various sensors to reduce uncertainty. In this application, it may be used to estimate orientation with respect to gravity and may be used in separating forces or sensed dynamics for data from a sensor. The on-device sensor fusion may provide other suitable sensor conveniences. Alternatively, multiple distinct sensors can be combined to provide a set of kinematic measurements.

The activity sensor device 100 can additionally include other sensors such as an altimeter, GPS, or any suitable sensor. Additionally, the system can include a communication channel via the communication module to one or more computing devices with one or more sensors. For example, an inertial measurement unit can include a Bluetooth communication channel to a smart phone, and the smart phone can track and retrieve data on geolocation, distance covered, elevation changes, land speed, topographical incline at current location, and/or other data.

A communication module functions to relay data between the activity sensor device 100 and at least one other system. The communication module may use Bluetooth, Wi-Fi, cellular data, and/or any suitable medium of communication. For example, the communication module can be a Bluetooth chip with RF antenna built into the device. As discussed, the system may be a standalone device where there is no communication module.

The system can additionally include one or more feedback elements, which function to provide a medium for delivering real-time feedback to the user. A feedback element can include a haptic feedback element (e.g., a vibrational motor), audio speakers, a display, or other mechanisms for delivering feedback. Other user interface elements for input and/or output can additionally be incorporated into the device such as audio output elements, buttons, touch sensors, and the like.

A processor system 200 of a preferred embodiment functions to transform kinematic data collected by the kinematic activity sensor device 100. The processor system 200 may include device processors of an activity sensor device 100 and/or external processors (e.g., application logic of a smart phone or a remote server).

The processor system is preferably configured to execute a configuration mode and a set of kinematic monitoring modes. The processor system may additionally include configuration to execute a calibration mode and/or perform any suitable task of the system. The processing can take place on the activity sensor device 100 or be wirelessly transmitted to a smartphone, computer, web server, and/or other computing system that processes the kinematic data and/or biomechanical signals.

The configuration mode preferably determines and selects an appropriate kinematic monitoring mode by detecting location and optionally a current activity as described herein. Accordingly, the processor may include configuration to execute a location detection mode and/or an activity detection mode. Both of these configuration modes preferably use base kinematic metrics (e.g., sensor data and/or initial biomechanical signal estimates) to determine a location and/or activity prediction.

A kinematic monitoring mode functions to be a direct biomechanical signal collection and application-specific function. When in a kinematic monitoring mode, the kinematic monitoring mode will be configured to collect a set of biomechanical signals using some set of biomechanical processing modules. A biomechanical processing module can characterize gait dynamics, a user activity graph, and/or other mobility metrics based on collected kinematic data. The processing modules are preferably specifically used based on the sensor location and/or activity. A first exemplary set of biomechanical processing modules measure properties of gait locomotion (e.g., walking, running and the like) and other biomechanical properties (e.g., posture). A second exemplary set of biomechanical processing modules may classify or detect various activity states.

### 3. Method

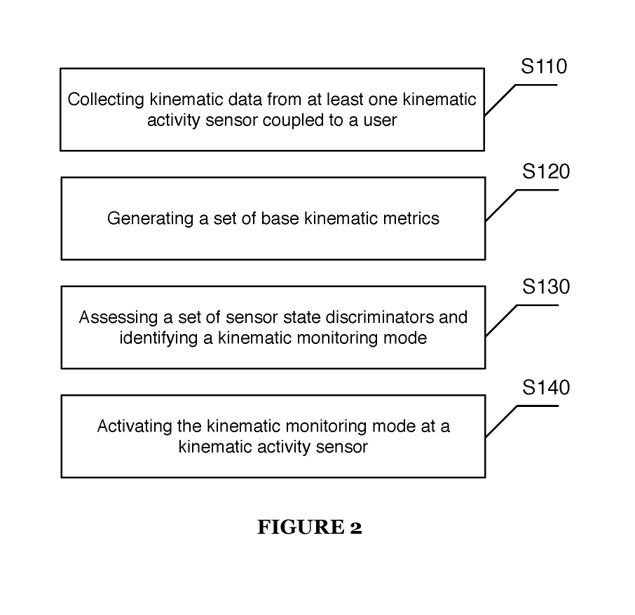

As shown in FIG. 2, a system for automatic location detection for wearable sensors of a preferred embodiment is an activity monitoring platform that may include collecting kinematic data from at least one kinematic activity sensor coupled to a user S110; generating a set of base kinematic metrics S120; assessing a set of sensor state discriminators and identifying a kinematic monitoring mode S130; and activating the kinematic monitoring mode at the at least one kinematic activity sensor S140. The method is primarily described as being applied to a single sensor, but as also described herein, the method may operate in connection to two or more kinematic activity sensors.

Block S110, which includes collecting kinematic data from at least one kinematic activity sensor coupled to a user, functions to sense, detect, or otherwise obtain sensor data relating to motion of a user.

The kinematic data can be collected with an inertial measurement system that may include an accelerometer system, a gyroscope system, and/or a magnetometer. Preferably, the inertial measurement system includes a three-axis accelerometer and gyroscope. The kinematic data is preferably a stream of kinematic data collected over periods of time detected activity. The kinematic data may be collected continuously but may alternatively be selectively activated in response to detected activity.

In one variation, data of the kinematic data is raw, unprocessed sensor data as detected from a sensor device. Raw sensor data can be collected directly from the sensing device, but the raw sensor data may alternatively be collected from an intermediary data source (e.g., wherein the method may include retrieving kinematic data from an outside sensor). In another variation, the data can be pre-processed. For example, data can be filtered, error corrected, or otherwise transformed. In one variation, in-hardware sensor fusion is performed by an on-device processor of the inertial measurement unit. The kinematic data is preferably calibrated to some reference orientation. In one variation, automatic calibration may be used as described in U.S. patent application Ser. No. 15/454,514 filed on 9 Mar. 2017, which is hereby incorporated in its entirety by this reference.

In one preferred implementation, when a user wears a sensor, the sensor detects motion and wakes up from a sleep mode. When the user begins walking or performing an activity, the sensor and system can generate a reference orientation frame before it begins location detection. In one example, once a sensor has been properly calibrated and configured, the data from the sensor can be processed to detect the specific location being worn on the user. Some variations of location detection may be performed prior to or without calibration. For example, location detection that uses magnitude measurements may not rely on calibration.

Any suitable pre-processing may additionally be applied to the data during the method. In one variation, collecting kinematic data can include calibrating orientation and normalizing the kinematic data.

An individual kinematic data stream preferably corresponds to distinct kinematic measurements along a defined axis. The kinematic measurements are preferably along a set of orthonormal axes (e.g., an x, y, z coordinate plane). As described below, the axis of measurements may not be physically restrained to be aligned with a preferred or assumed coordinate system for a given sensor position. Accordingly, the axis of measurement by one or more sensor(s) may be calibrated. One, two, or all three axes may share some or all features of the calibration, or be calibrated independently. The kinematic measurements can include linear acceleration, linear velocity, linear displacement, force, angular acceleration, angular velocity, angular displacement, tilt/angle, and/or any suitable metric corresponding to a kinematic property of an activity. Preferably, the kinematic activity sensor provides acceleration as detected by an accelerometer and angular velocity as detected by a gyroscope along three orthonormal axes. Velocity and displacement metrics of biomechanical motions can be generated from these measured kinematic data streams once an appropriate kinematic monitoring mode is identified. The set of kinematic data streams preferably includes linear acceleration in any orthonormal set of axes in three-dimensional space, herein denoted as x, y, z axes, and angular velocity about the x, y, and z axes. Additionally, the sensing device may detect magnetic field through a three-axis magnetometer.

The kinematic monitoring sensor is preferably attached to the user at some location. The method preferably facilitates automatically determining the attachment location. Some exemplary locations that may be detected include positions at the foot, pelvic/waist region, chest/clavicle region, on an arm, on the head, and/or at other suitable locations.

In the case of multiple kinematic activity sensors being used simultaneously, block S110 may include collecting from a plurality kinematic activity sensors positioned at distinct locations on a user. A set of activity sensors that are being worn preferably synchronize to common time-stamp such that the kinematic data from multiple sensors is time-aligned. This can be done with the activity sensors connecting with each other or with a peripheral device such as a smart phone or smart watch that has a reliable real-time clock.

Block S120, which includes generating a set of base kinematic metrics, functions to transform the kinematic data into at least one metric that can be used in block S130. The base kinematic metrics are intended to facilitate discriminating between different modes of use of an activity sensor. There is preferably a plurality of base kinematic metrics that can be measured. The base kinematic metrics may be measured prior to having an estimate of the location and, as such, generated during each configuration process. A subset of the base kinematic metrics may be measured upon making a partial assessment of activity sensor location and/or activity. For example, one subset of base kinematic metrics may be generated after using a first base kinematic metric(s) to determine if the activity sensor is positioned at a foot or somewhere on the upper body.

An exemplary set of base kinematic metrics can include a base activity segmentation signal, a step impact magnitude signal, displacement dynamics, and/or angular dynamics metrics. In some variations, estimates of biomechanical properties may additionally be calculated such as stride length, ground contact time, and other biomechanical signals.

Generating a base kinematic metric may apply a data transformation that is distinct from subsequent transformations used during a final kinematic monitoring mode, but the data transformation may alternatively be a variation of a transformation eventually used in one of the possible kinematic monitoring modes. For example, a generic step segmentation process may be used for a base step segmentation metric, and, upon determining the kinematic monitoring mode, a specialized step segmentation metric customized to the particular location may be used.

A base activity segmentation signal functions to estimate windows of repeated actions. In general this segments the kinematic data based around walking and running steps. Alternatively, the activity segmentation signal could be based around any suitable repetitive type of activity such as repeated exercises like squats, lunges, or barbell lifts. The base activity segmentation preferably applies general segmentation that is sufficient to segment kinematic data as it may be collected from a plurality of locations and/or for a plurality of activity types.

Step impact signal may function to indicate location of a sensor on the body based on the nature of step impact experienced at different locations of the body. A step impact signal is a characterization of step impact within a step. The steps may be determined or based on the activity segmentation above. A detectable step impact signal translates throughout the body. The step impact signature will generally diminish the further the location is from the initial point of impact, in this case at the heel of the foot. The step impact signal may be characterized as a signal pattern (e.g., a step impact signature). The body may act as a filter where different components of a step impact signature are evident when measured at one location, which may be different from the components when measured at a second location. Block S120 more preferably generates a step impact magnitude metric as part of generating the base kinematic metrics. During normal walking, the accelerometer magnitude at the foot/shoe is significantly higher than the magnitude felt at the pelvis, wrists, core and head. The step impact magnitude metric may be used as a discriminator feature to distinguish between a sensor worn on the foot and one worn in the upper body.

In one implementation, generating the step impact magnitude metric includes averaging the peak step impact magnitudes during the user's walk. The step impact magnitude may then be applied in block S130 to detect location and identify a kinematic monitoring mode. If the sensor is positioned on the foot, the average peak magnitude would be much larger than the peak magnitudes of a sensor located anywhere else on the body because impact magnitudes of this value are usually not felt anywhere else on the body when a person is walking. In one implementation, the average peak magnitude is greater than a threshold (e.g. 4 G's) that may indicate the sensor is positioned on one of the two feet and is located elsewhere if less than the step impact threshold.

The process of generating a base displacement dynamics metrics functions to characterize linear displacement, velocity, or acceleration properties along one or more axes. In one implementation a displacement and/or angular velocity path can be used to discriminate between right and left positions when the activity sensor is worn on the arm or leg/foot.

The process of generating a base angular dynamics metrics functions to characterize angular displacement, angular velocity, or angular acceleration properties. In one exemplary implementation, range of angular rotation within activity segments can be used to discriminate between at least two kinematic monitoring modes.

Block S130, which includes assessing a set of sensor state discriminators and identifying a kinematic monitoring mode, functions to process the base kinematic metrics to classify the location and/or activity. More generally, block S130 is applied in detecting sensor location and/or detecting a current activity. Detecting sensor location in one variation can include applying assessment of a set of sensor state discriminators that can be used in predicting sensor regional location through different patterns in the kinematic data.

Assessing a set of sensor state discriminators may apply heuristic-based rules and/or apply one or more machine learning models to classifying location and/or activity. Heuristic-based discriminators and machine learning discriminators may be used separately or in combination. The set of different sensor state discriminators are preferably ordered to be applied in a logical manner. However, at least a subset of sensor state discriminators may be assessed independently.

A sensor state discriminator will preferably specify, select, or predict one sensor state candidate. The candidate can be a location candidate that predicts position of a sensor. Some location candidates may be general such as predicting the sensor is at some location on the torso or specific such as predicting the sensor is on the right wrist. The candidate could also be an activity candidate such as predicting that the current activity is running.

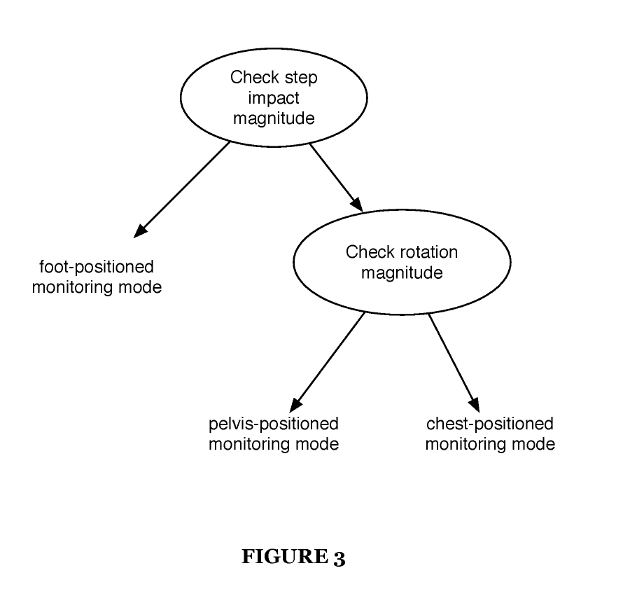

The set of sensor state discriminators can include regional discriminators. A regional discriminator functions as a location detector to select one of a set of location candidates. A sequence of different regional discriminators may be assessed. In one variation, block S130 may include assessing a first regional discriminator to identify one of at least a first and second location region, and, when the first location region is identified, assessing a second regional discriminator to identify one of a third location region and a fourth subregion. In an example shown in FIG. 3, a regional discriminator may identify if the sensor is located on the upper body or the foot (e.g., the first and second regions), and a second regional discriminator may be used to distinguish if the sensor is located at the pelvis or at the clavicle region after its detected to be on the upper body (e.g., the third and fourth regions).

In one implementation of the example above, the first regional discriminator can assess a step impact magnitude metric from block S120 wherein the foot-position is identified when the step impact magnitude metric is above a threshold value and the upper body is identified when the step impact magnitude metric is below the threshold value. An alternative regional discriminator may assess vertical displacements. A foot-positioned activity sensor will generally experience more vertical displacements (e.g., greater than 8 centimeters) and a pelvic-positioned activity sensor will generally experience less vertical displacements (e.g., less than 4 centimeters). A threshold between 4 and 8 centimeters may be used to identity as foot-positioned or pelvic-positioned in an exemplary implementation. The second regional discriminator may assess a rotational metric to distinguish between the pelvic position and a clavicle-position (e.g., chest position). An activity sensor on the pelvis experiences more rotation.

The set of sensor state discriminators can additionally include a right-left discriminator that functions as a right-left side detector. Assessing the right-left discriminator and identifying a right or left location specific kinematic monitoring mode is generally applied if a particular location candidate is identified that has a right-left distinction. A right-left discriminator is preferably applied when the sensor is identified as being positioned on the foot, leg, arm, or hand.

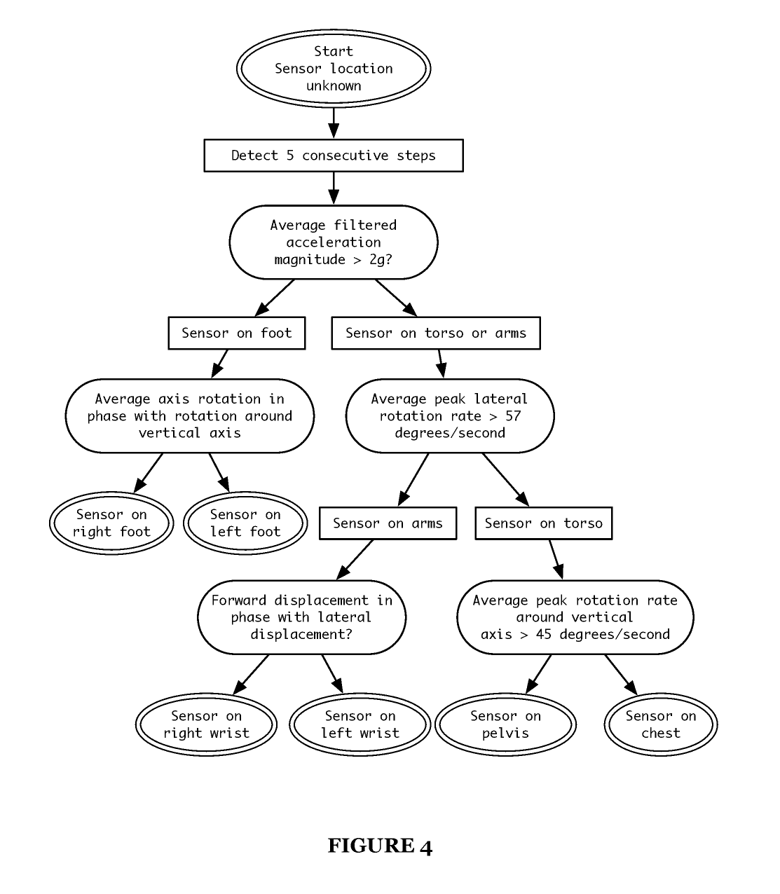

In a more specific example shown in FIG. 4, after waiting for a base number of step segments, a first regional discriminator may check for step impact magnitude greater than 2 G's to determine a foot-position candidate if the condition is valid (e.g., greater than 2 G's) or a non-foot candidate if the value is not valid (e.g., less than 2 G's). More generally the condition of the first regional discriminator could be on average filtered acceleration signals greater than 2 G's. For a foot-position candidate, a right-left foot discriminator may verify if the initial lateral axis rotation of each step is substantially in phase with rotation around a vertical axis to determine a right-foot position if the condition is true and a left-foot position if the condition is false. The phase alignment conditions will depend on axes orientation. In this example, the considered axes are aligned such that the vertical axis is positive upward and the lateral axis is positive to the right. So in this example, for the right foot, the lateral axis rotation and vertical axis rotation both go negative. Whereas, for the left foot, the lateral axis rotation goes negative and the vertical axis rotation goes positive initially. In the case of the non-foot candidate scenario above, an arm-torso discriminator could verify if the average peak lateral rotation rate is greater than an angular velocity threshold (e.g., 57 degrees/second) to determine an arm position if valid and a torso position if not valid. In the case of an arm position, a right-left discriminator could verify if forward displacement is in phase with lateral displacement to determine a right-arm position if valid and a left arm position if invalid. As with above, the phase alignment conditions will depend on axes orientation. In this example, the considered axes are aligned such that the vertical axis is positive upward and the lateral axis is positive to the left. In the case of a torso position, a pelvis-chest discriminator could verify if an average peak rotation rate around a vertical axis is greater than 45 degrees/second to determine a pelvis position if valid and a chest position if invalid. Different kinematic monitoring modes could be identified for each of the candidate positions. For example, a simplified flow diagram may result in a foot-position monitoring mode during the condition of determining the foot-position candidate.

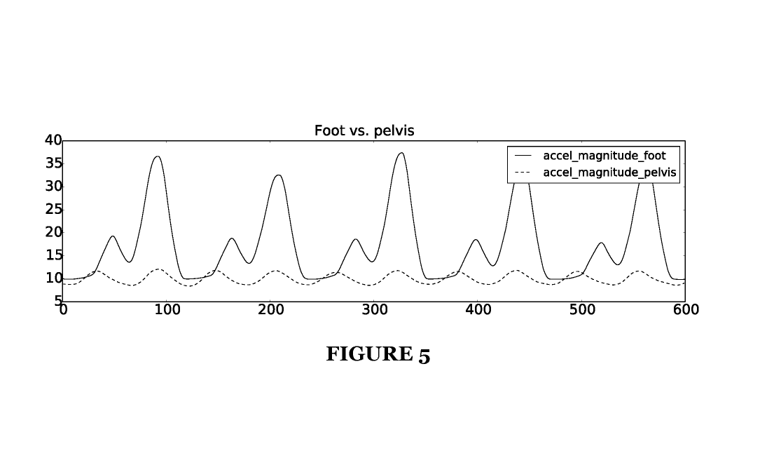

A sensor state discriminator for a foot and upper body discriminator can use a base kinematic metric that is an acceleration magnitude. The acceleration magnitude may be a filtered signal. In one example, the base kinematic metric is a lowpass-filtered acceleration magnitude. As shown in FIG. 5, setting a condition at 20 m/sec² (or about 2 g) could be a suitable threshold for determining foot or upper body position. An alternative sensor state discriminator for a foot and upper body discriminator could use step segmentation. A foot-positioned activity sensor would experience more prominent step impacts every other foot and in some cases may be segmented for each stride, whereas an upper body discriminator may experience each step more uniformly and so would segment for each step. Accordingly step segmentation would have different periods.

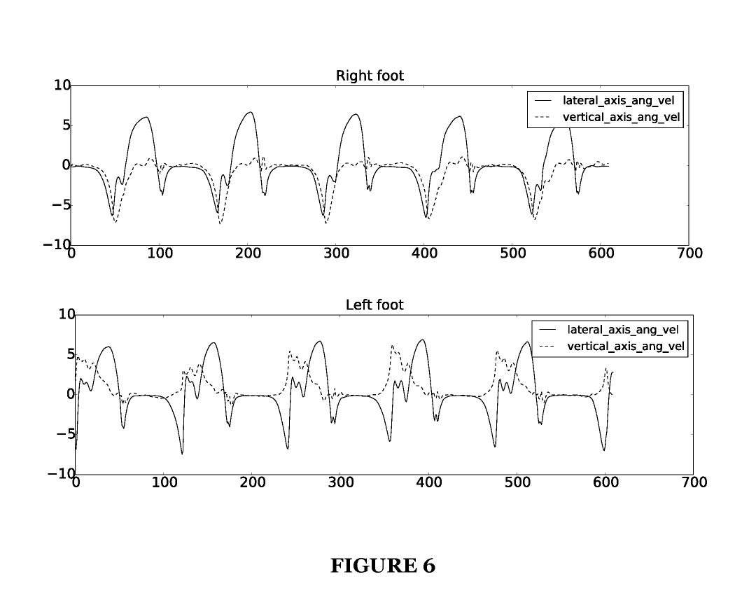

A sensor state discriminator for a right-left foot discriminator can use rotation speed in degrees/second as measured by a gyroscope around a lateral axis (e.g., in the horizontal plane, pointing to the right) and around the vertical axis (e.g., pointing up). As shown in FIG. 6, left-vs-right foot may be determined by whether the lateral signal and the vertical signal both trend in the same direction at the beginning of each step (as they do for the right foot) or if they trend in opposite directions (as they do for the left foot). This discriminator operates based on a user's right foot tending to swing the toes out toward the right as the foot is picked up and then back toward the midline as the foot is set down again. The left foot tends to do the opposite.

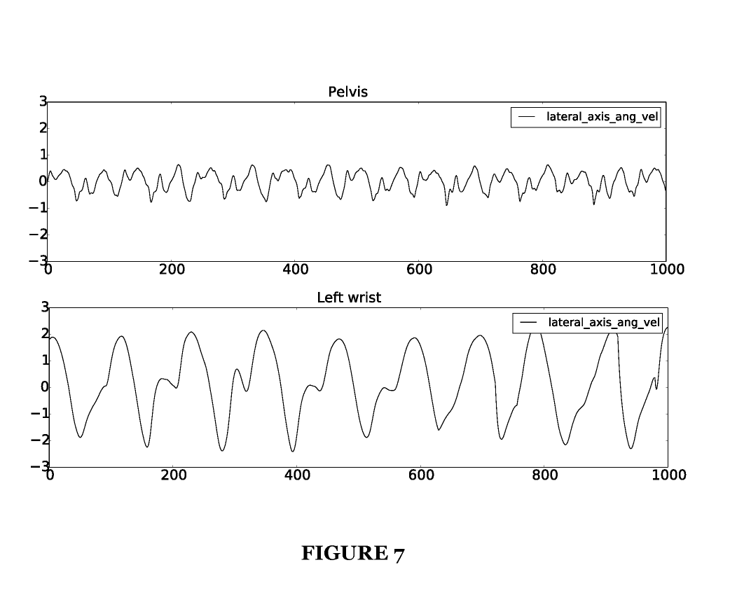

A sensor state discriminator for an arm and upper body discriminator may use lateral axis rotation as a base kinematic metric. A lowpass-filtered version of the lateral axis rotation metric as shown in FIG. 7 are significantly higher in the arm than experienced on the upper body. In this example the lateral axis is oriented to the right. In some cases, the peak values at the arm are three times greater.

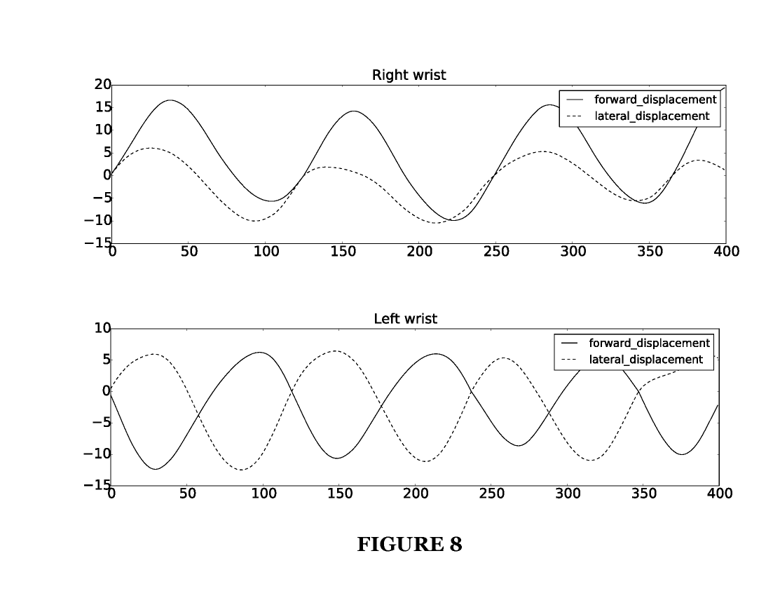

A sensor state discriminator for a right-left arm discriminator can use lateral and forward displacement as a base kinematic metric. The relative phase of forward and lateral displacements can be an indicator of right or left wrist. As shown in FIG. 8, the forward and lateral displacements tend to be approximately 180 degrees out of phase for the left wrist and approximately in phase for the right wrist. A phase alignment condition will depend on the definition of the axes' directions. Accordingly, the right-left arm discriminator can be more generally described as identifying a right side for a first forward and lateral displacement phase alignment and identifying a left side for a second forward lateral displacement phase alignment.

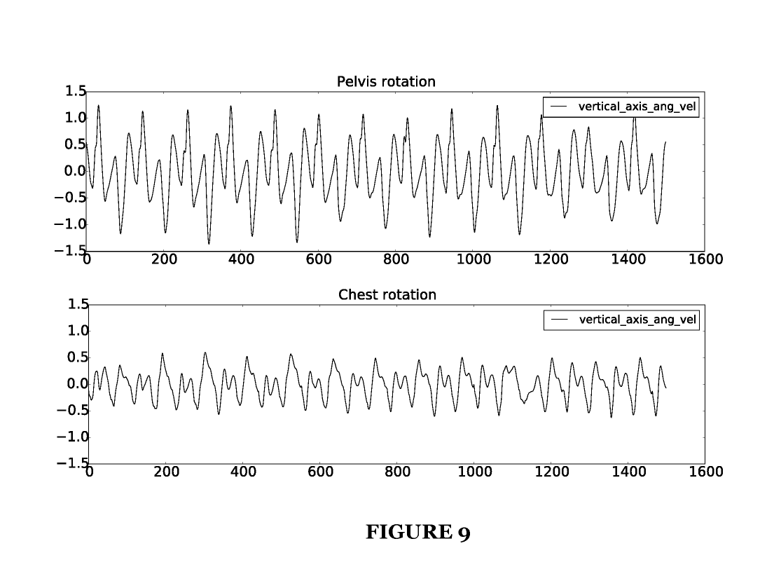

A sensor state discriminator for a pelvis and chest discriminator can use rotation speed as the base kinematic metric. The pelvic rotation in the horizontal plane (e.g., transverse plane) is generally greater for an activity sensor on the pelvis but is reduced when the activity sensor is higher on the torso (e.g., at the chest). Here rotation of the sensor may be measured in total rotation amount in degrees and/or in rotation speed. As shown in FIG. 9, the magnitude of rotation speed can be used to set a threshold to determine pelvis or chest location

The set of sensor state discriminators can additionally include a set of activity discriminators. An activity discriminator functions as an activity detector to classify at least one activity. An activity discriminator may be customized for a particular location. For example, after the pelvis region of the activity sensor is identified, an activity discriminator may identify if the user is walking or running.

The set of sensor state discriminators estimate the current sensor state to identify which, if any, kinematic monitoring modes should be used at a given time. Kinematic monitoring modes are at least partially based on location and/or activity. Part of identifying a kinematic monitoring mode can include determining position of an activity sensor and/or determining a current activity. The identified kinematic monitoring mode can then be selected based on a mapping that associates different kinematic monitoring modes with particular positions, activities, and/or position-activity combinations.

The kinematic monitoring modes may be associated with different sensor locations. In one variation, identifying a kinematic monitoring mode can include selecting a kinematic monitoring mode selected from a set of kinematic monitoring modes that can include a foot-positioned monitoring mode, a pelvic-positioned monitoring mode, a chest-positioned monitoring mode (e.g., a clavicle-positioned monitoring mode), an arm/hand-positioned monitoring mode, and/or a head-positioned monitoring mode. Additionally, right and left monitoring mode variations may be selected for foot, leg, arm, hand, and/or other suitable positions.

The kinematic monitoring modes may additionally be associated with different activities. In one variation, identifying a kinematic monitoring mode can include selecting a kinematic monitoring mode from a set of kinematic monitoring modes that can include a walking gait monitoring mode, a posture monitoring mode, a running monitoring mode, an exercise training monitoring mode, a neck posture monitoring mode, and/or any suitable monitoring mode.

A set of supported kinematic monitoring modes is preferably mapped to different locations or optionally location-activity combinations. There may not be a kinematic monitoring mode for each permutation of location and activity. Some kinematic monitoring modes may be specific to the position and current activity. Some positions may only support monitoring for particular activities. In one variation, identifying a kinematic monitoring mode can include selecting a kinematic monitoring mode selected from a set of kinematic monitoring modes that includes various position and activity combinations. The set of kinematic monitoring modes may include kinematic monitoring modes such as a foot-positioned walking gait monitoring mode, a foot-positioned running monitoring mode, a pelvic-positioned walking gait monitoring mode, a pelvic-positioned running monitoring mode, a pelvic-positioned posture monitoring mode, and an upper-body-positioned posture monitoring mode.

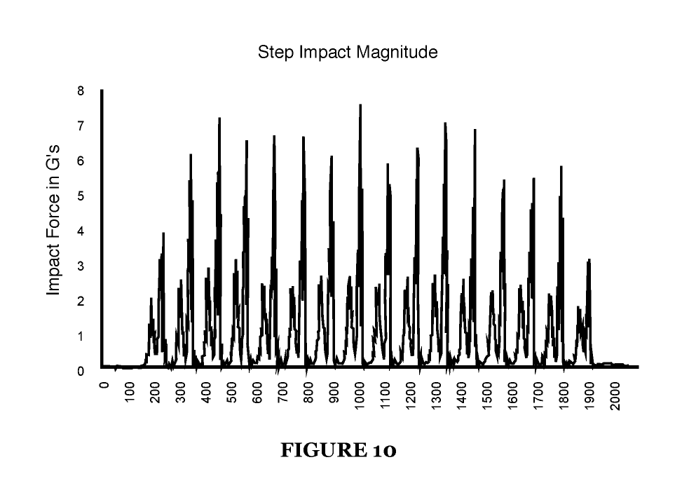

In one example of a heuristic-based discriminator, step impact magnitude may be used to form a first estimate of a candidate location. Estimating a candidate location is then used in identifying a kinematic monitoring mode. As described above kinematic monitoring modes may be directly associated with a location and activity combination. In one approach of a heuristic-based discriminator, the average peak step impact magnitudes during the user's walk are measured. If the average peak magnitude is greater than a threshold (e.g. greater than 2 G's or 4 G's) that would be much larger than the peak magnitudes of a sensor located anywhere else on the body because impact magnitudes of this value are usually not felt anywhere else on the body when a person is walking. As shown in FIG. 10, the step impact magnitude as measured from the foot of a user while walking may experience peak acceleration greater than a 4 G threshold.

In another example of a heuristic-base discriminator, assessing a sensor state discriminator can include detecting if a left foot position or a right foot position by quantifying an average lateral displacement metric. When a person is walking, there is a natural rotation that swings the foot towards the body's Center of Mass (CoM). In one variation, the state discriminator may analyze the lateral swing displacement, the average displacement, and angular velocity throughout the swing phase to determine if the device is on the left or right foot.

If the step impact magnitude is categorized as a moderate value, then the sensor may be placed on the core or the arms. In the case of detecting if the device is being worn on the arm, a separate sensor state discriminator can be assessed for detecting an arm swing can be used which may identify right or left arm or further reinforce identification of the location as the arm location. In the case of detecting if the device is on the core, then a separate sensor state discriminator can be applied to determine a pelvis or clavicle position.

In another example of a heuristic-based discriminator, assessing arm-positioned discriminator can include assessing base kinematic metrics that are segmented based on arm motion (e.g., arm swings). Various base kinematic metrics can be used to detect if the device is on the arm. The arm swing can be quantified and correlated with previously recorded arm swings. The angular velocity threshold in the forward/backward plane of the device can be analyzed for detecting arm swing motion. In addition, the consistent forward/backward displacement of the arm swing can be quantified in the transverse and sagittal planes.

If a sensor state discriminator identifies an arm-position, then a secondary right-left arm discriminator may be assessed to determine if the device is worn on the right arm or the left arm by analyzing the lateral displacement curve of the device. Similar to detecting left foot or right foot, arm swings follow a natural path that has a slight rotation towards the user's center of mass. The lateral swing displacement and angular velocities can therefore be analyzed to determine if the device is being worn on the left hand or right hand.

If a sensor state discriminator determines the position to not be the arm, if, for example, no arm swing is detected, then the sensor device may be located on the upper core/clavicle or lower back/pelvis. If the device was located on the pelvis, the device will exhibit a moderate and similar angular rotation every two steps. This pattern is repeated every two steps which completes a pelvic rotation cycle. The moderate rotations are most significant in the coronal and transverse planes. This pattern is due to the natural movement of the pelvis as the user walks. If there is very little rotation in the coronal and transverse planes, then the device is determined to be worn on the upper clavicle. This inference is because the clavicle is not subjected to the rotational pattern like the pelvis. The upper core maintains a relatively low rotational dynamic. A sensor state discriminator could additionally or alternatively be assessed to distinguish between pelvic position and an upper clavicle position.

Another potential sensor state discriminator can be a head discriminator, which can function to detect if the activity sensor is being worn on the head, such as on a helmet, embedded into a pair of eyeglasses or headphones. In one variation, this may, in part, be done by using the step impact magnitude threshold. A head discriminator detector may assess the step impact magnitude metric relative to a threshold, as well as the peak changes in angular velocity and angular displacement. Significant changes in angular velocity and displacement can be a characteristic of the head. During a walking motion or sedentary activity, the head is able to generate significant changes due to the natural ability and need to have spatial awareness. Additional indicators include detecting angular velocity changes during moments when the user is standing, sitting or in the double-stance phase of a walking gait cycle.

In some variations, the method may be applied to the simultaneous use of multiple sensors wherein collecting kinematic data includes collecting from a plurality sensors positioned at distinct locations; generating the base kinematic metrics includes generating at least a first set of relative metrics; and wherein identifying a kinematic monitoring mode comprises identifying a kinematic monitoring mode for each of the plurality of sensors. A relative metric preferably compares metrics from at least two sensors. A sensor state discriminator can use a relative metric in detecting a location and/or an activity. Individual sensor state discriminators as described herein may additionally be used in identifying a candidate location and activity.

When multiple sensors are worn simultaneously on the body, the set of activity sensors can communicate information such as kinematic data, base kinematic metrics like step impact magnitude and other relevant data to a central resource for generation of relative metrics. The activity sensors may communicate with each other or with a connected computing device (e.g., a phone or a remote server). In a multiple sensor variation, Block S120 can include generating relative metrics that are comparisons of different metrics between different sensors. The data from the different sensors are preferably time synchronized. The data may alternatively be synchronized around key kinematic features identifiable in the kinematic data from each sensor.

For example, for walking or running motion, sensors on the foot or tibia would expect to sense the largest magnitudes for activities like walking or running, relative to the sensors at other locations like the head, which will detect smaller magnitudes, and sensors on the core and arms may experience impact magnitudes in the middle. A relative comparison may serve as a suitable alternative to assessing individual metric. Other types of activities may alternatively have different signal magnitudes that can be used in other ways to discriminate between locations on the body.

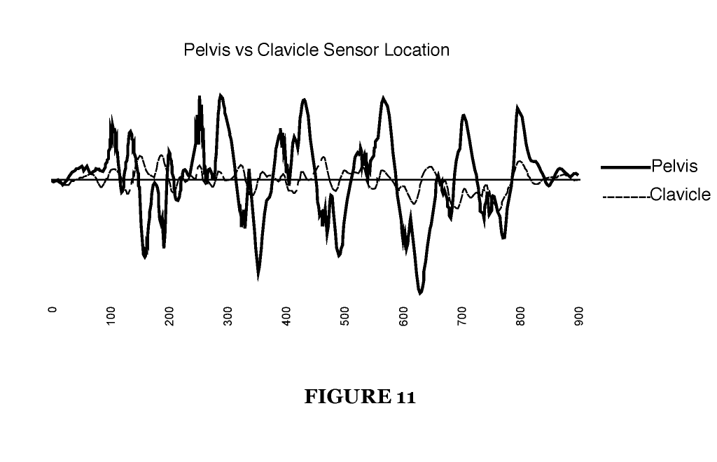

An increase in the number of sensors worn on the body may also minimize the uncertainties or errors associated with sensor location detection where sensors are located close to each other. For instance, wearing Sensor A on the clavicle and Sensor B on the waist will give the model significantly more certainty that Sensor A is located on the clavicle and not on the waist with Sensor A & B worn as opposed to when only Sensor A is worn. Furthermore, as seen in FIG. 11, Sensor B may exhibit a stronger and more consistent rotation dynamic, than compared to Sensor A. Whereas both may exhibit similar step impact magnitude values.

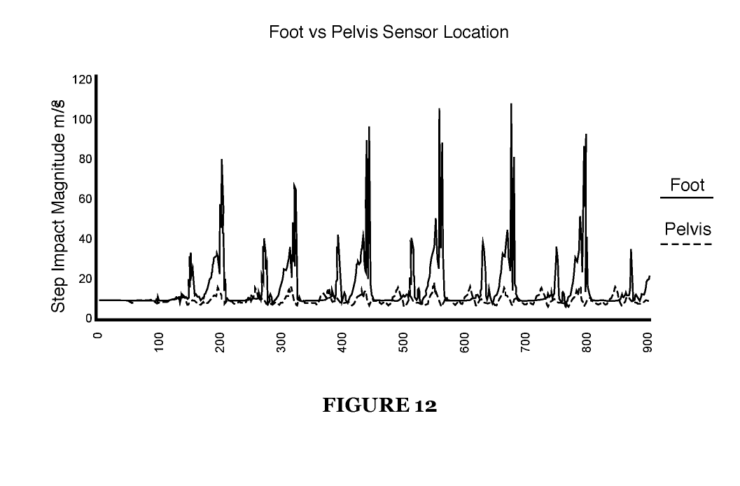

In another implementation with a user wearing two sensors (Sensor B on pelvis and Sensor C on foot), the system can compare the relative values against each sensor and also use thresholds to validate the location determination. As can be seen in FIG. 12, the step impact magnitude is calculated at both the foot and the pelvis. Sensor C's peak step impact magnitude is significantly greater than Sensor B's peak step impact magnitude. In addition, if the peak step impact magnitude reaches a threshold of greater than 40 m/s² (4 G's) this can also further validate that the sensor is on the foot, while Sensor B's peak step impact magnitude falls between 10-20 m/s² (1-2 G's).

In another variation, relative metrics can be assessed to detect right or left sides. In one implementation, relative metrics are assessed to detect whether a sensor is located on the left or right side of the core, or in the center. For example, a sensor that was initially placed in the center of the waist can detect if it has shifted to the left or right. If it has shifted too much, the sensor can alert the user to move it back to the original location. In addition, if the sensor was placed initially in the wrong location, the user can be notified immediately after being detected.

As an additional or alternative approach to a relative metric, the relative timing of detectable kinematic events as they traverse through the human body may be used to predict sensor location. The activity sensors are preferably time synchronized, and therefore timing of peak step impact magnitude measured across different sensor locations may be detectably offset in time. For example, sensors located at the foot measure the impact magnitude first. Then as the body begins to absorb the impact along the legs, pelvis, core and head, each sensor at those specific locations will sense the impact signature, with the head at the very end.

Multiple sensors may additionally be used to augment the execution of a kinematic monitoring mode. Multiple sensors may work together to perform a deeper and more comprehensive characterization of various biomechanical properties. For example, sensors on the foot can be used to segment the raw kinematic data on the pelvis of a user where the signal to noise ratio may be too low. For example, when a user shuffles his/her feet, the step segmenting signal is very strong on the foot, but weaker on the pelvis.

In one variation, the particular combination of sensor locations may result in identifying individual kinematic monitoring modes for use that are customized to leverage the available capabilities. In particular, identifying a kinematic monitoring mode can include identifying a kinematic monitoring mode for each of the plurality of sensors; and selectively activating a kinematic monitoring mode based on combined kinematic monitoring mode of the set of sensors. In other words, a kinematic monitoring mode is customized for a particular activity sensor based in part on the location of the activity sensor and at least the location of a second activity sensor. The current activity may additionally alter the kinematic monitoring mode. For example, a foot sensor and a pelvic sensor may each operate in a first run-monitoring mode, but if the sensors are repositioned to be a pelvic sensor and a clavicle sensor they may each operate in a second run-monitoring mode. The pelvic sensor though used in a run-monitoring mode in both instances may be used to generate biomechanical signals in different ways depending on the position of the other activity sensor.

Additionally, the method may include detecting a change in activity and updating the kinematic monitoring mode at the kinematic activity sensor to one associated with the new activity. A change in activity may occur after the location of a sensor has been detected. In this case, a new activity may be detected. If the user transitions from running to a static activity, such as standing or sitting, the pelvic and clavicle sensor can switch from a running monitoring mode to a posture monitoring mode. This switch can be automatically determined by measuring the kinematic energy or detecting Activity of Daily Living (ADL) activity states such as walking, running, sitting, standing and lying down. The methods for determining ADLs are described in U.S. Pat. No. 8,928,484, issued 6 Jan. 2015, which is incorporated in its entirety by this reference. Changing an activity may be detected and used in identifying a new kinematic monitoring mode and as a result changing the kinematic monitoring mode may result in one or more sensors changing the collection of biomechanical signals.

In one example, a sensor placed on the pelvis can switch between monitoring modes for each ADL activity that is detected. For example, the sensor can switch to a running mode when a user is running. The running mode may use a higher sampling frequency and different set of filters and sensor fusion parameters to perform optimally in a running environment. When the sensor detects the user has transitioned to walking, the sensor can automatically switch to a walking gait mode. The walking gait mode may have different sampling frequencies, filters and sensor fusion parameters to perform optimally when a user is walking. When the sensor detects a user has transitioned to a sitting or standing state, the sensor can automatically switch monitoring modes to a posture monitoring mode. The posture monitoring mode may perform different computations that are more important to a user such as determining posture and providing feedback. Finally, if the sensor detects that a user has transitioned to a laying down activity, the sensor can automatically switch to a sleeping monitoring mode.

In another example, a foot sensor can operate in a walking gait monitoring mode but can switch to a running monitoring mode, a biking monitoring mode or any suitable monitoring mode. There are kinematic energy differences in magnitude and pattern that the sensor can use to differentiate between walking, running, biking and other activities. For example, differences between running and walking include differences in impact magnitude, impact frequency, and changes in vertical step height (see below). Differences in running/walking and biking include lower and smoother impact magnitudes and more cyclical angular velocities and displacements due to the nature of pedaling. The sensor can switch monitoring modes to more accurately and optimally measure the appropriate biomechanical signals for that activity. For example, as noted above, the sampling frequency, filters and sensor fusion parameters may be automatically adjusted, as well as the algorithmic computations.

In addition or as an alternative to a human biomechanical heuristics model, the system can leverage machine learning models to determine the location of the device. One or more sensor state discriminators can be a machine learning model. This can be done with both supervised and unsupervised learning techniques. In supervised learning, training sets of labeled data can be used to build a model. Machine learning models may be used for single activity sensor variations as well as multi-sensor variations.

The first approach is to use a population classification model based on labeled data of raw auto-calibrated sensor data and the sensor location. The dataset can be labeled and continually learn with additional input from new users who specify the initial sensor location during setup. The machine learning models can be used to improve accuracy of detecting sensor locations and/or activities for all users.

Another approach may train on labeled data of a specific user. The machine learning models can be used to improve the accuracy of detecting sensor location and/or activities in a customized manner for a user.

Specific machine learning approaches include linear regression, multi-layer neural networks, support vector machines, Bayes Nets, and deep learning networks to identify common characteristics that can be used to classify sensor location. By using a supervised machine learning algorithm, the algorithm can generalize to new individuals and new behaviors.

Another approach is to use an unsupervised clustering algorithm to find groups of data that are most dissimilar. These approaches include k-means, expectation-maximization algorithms, density-based clustering, principal component analysis, and auto-encoding deep learning networks to identify different states, which would correspond to different sensor locations. By using an unsupervised learning algorithm, the model can find natural boundaries between the movement behaviors and the sensor locations.

The sensor location data and model can be stored on the device, uploaded in real-time or periodically to a software application that manages multiple sensors on an external computing device such as a smart phone, smart watch, or computer. Data can also be synced with web services in the cloud.

Another approach is to combine a human heuristics logic model and machine learning model to improve the location detection over time. Every individual has a unique walk. Some people strike the ground harder and therefore exhibit a much larger step impact magnitude. Other people may have a larger stride and a larger arm swing. Some may rotate their hips while they walk more than others. Additional characteristics change with the type of clothing or shoes that are being worn.

All of these nuances can be tuned with a learning model that captures user data from each sensor location as a user walks to help tune personal thresholds and values specific to the individual. Overtime, these thresholds may change depending on the user behavior.

Data related to assessing a sensor state discriminator and identifying a kinematic monitoring mode (e.g., identifying a sensor location and optionally an activity) may be stored on the device, in a peripheral computing device or on a web server/cloud database to help train models in the cloud and take advantage of macro or longitudinal trends to improve sensor location detection accuracy. If new sensor devices are added to the system, the sensors can be updated with the learned models and relative thresholds when the user connects their new sensor to the software application.

Additionally, family members can share sensor devices across the family. Each individual family member can have their own user account that propagates their corresponding configurations to the sensor upon connection.

In addition to kinematic data collected from the activity sensors, the method may additionally collect and use other supplemental signals such as biometric signals, location signals (e.g., GPS detected location), and communication. Biometric signals may be various signals as collected by an electromyography (EMG) sensor, a pulse oximeter sensor, a temperature sensor, a galvanic skin response (GSR) sensor, and/or other suitable biometric sensors. As one particular example, the method may include measuring a communication received signal strength indicator (RSSI) and/or roundtrip lag time between each sensor and a communication device. The communication can be a smart phone, a smart watch, or any suitable computing device. The communication RSSI may be the Bluetooth RSSI. When the software application session of the communication device is active and detecting finger inputs or detects hand motion using the smart phone's IMU sensors or touch sensors, the system can determine that the smartphone is being held and most likely in front of the user's field of view as the user interacts with the application. The system can then calculate the relative RSSI and round trip packet lag between the smartphone and each sensor.

The human body is a large signal attenuating barrier, which can significantly reduce RSSI. The RSSI values with a sensor located on the front of the body will generally be significantly greater than a sensor located in the back of a user. When the sensor is located in the front and the phone is detected to be in front of the user, there is a clear line of sight connection which enables strong RSSI values, whereas the sensor located on the back does not. For example, sensors on the arm will have the strongest RSSI values, whereas the head and foot will have low RSSI values. Similarly, sensors on the upper clavicle or front of the waist will have high RSSI values, where as a sensor located on the lower back (pelvis) would have the lowest RSSI values.

Block S140, which includes activating the kinematic monitoring mode at the at least one kinematic activity sensor, functions to operate the system in a mode based on its location and optionally the current activity. Each kinematic monitoring mode preferably includes generating a mode-specific set of biomechanical signals where the set of biomechanical signals for two different monitoring modes may not be the same in some cases. The kinematic monitoring mode preferably acts on the collected kinematic data of the activity sensor.

Generating a mode-specific set of biomechanical signals, functions to transform one or more elements of the kinematic data into biomechanical characterizations of static or locomotion-associated actions or states (generally referred to as biomechanical signals). The biomechanical signals are preferably measurements of some aspect relating to how the user moves their body when walking, running, standing, performing exercise training actions, or during any suitable activity. The method can additionally include quantifying other biomechanical aspects that may not be exclusively associated with locomotion such as posture (e.g., when standing, sitting, or lying down) and/or health related metrics (e.g., tremor quantification, limp detection, shuffle detection, fatigue detection, etc.).

The set of biomechanical signals may be different for different monitoring modes. For example, the biomechanical signals generated by a sensor located at the foot may be different from a sensor located at the pelvis. Furthermore, the processing module applied in generating a specific biomechanical signal may be specific or customized to the particular monitoring mode. Accordingly, generating a set of biomechanical signals may be generated through processing modules that are customized to the identified kinematic monitoring mode. For example, step segmentation may be different when performed for foot-based gait analysis, pelvic-based gait analysis, and pelvic-based run analysis. Various thresholds, forms of error correction, signal patterns, machine learning models, kinematic data signals (e.g., vertical acceleration vs. lateral acceleration), algorithmic processes, and/or other aspects of generating a biomechanical signal can be customized to different monitoring modes.

In one variation, biomechanical signals may be generated in a manner substantially similar to that described in U.S. patent application Ser. No. 15/282,998, filed 30 Sep. 2016, which is hereby incorporated in its entirety by this reference.

Generating locomotion biomechanical measurements can be based on step-wise windows of the kinematic data—looking at single steps, consecutive steps, or a sequence of steps. In one variation, generating locomotion biomechanical measurements and more specifically gait biomechanical measurements can include generating a set of stride-based biomechanical signals comprising segmenting kinematic data by steps and for at least a subset of the stride-based biomechanical signals generating a biomechanical measurement based on step biomechanical properties. Segmenting can be performed for walking and/or running. In one variation steps can be segmented and counted according to threshold or zero crossings of vertical velocity. A preferred approach, however, includes counting vertical velocity extrema. Another preferred approach includes counting extrema exceeding a minimum amplitude requirement in the filtered, three-dimensional acceleration magnitude as measured by the sensor. Another preferred approach may count segments by identifying threshold crossings or extrema in vertical acceleration followed by identification of subsequent plateau regions in vertical velocity of relatively constant value or other specific criteria. Requiring two or more conditions to be satisfied to count segments may improve accuracy of the segmentation when the input waveforms are predominantly non-periodic or noisy. Different approaches may be used in different conditions.

The set of stride-based biomechanical signals can include step cadence (number of steps per minute); ground contact time; left or right foot stance time; double stance time, forward/backward braking forces; upper body trunk lean; upper body posture; step duration; step length; swing time; step impact or shock; activity transition time; stride symmetry/asymmetry; stride speed, left or right foot detection; pelvic dynamics (e.g., pelvic stability; range of motion in degrees of pelvic drop, tilt and rotation; vertical displacement/oscillation of the pelvis; and/or lateral displacement/oscillation of the pelvis); motion path; balance; turning velocity and peak velocity; foot pronation; vertical displacement of the foot; neck orientation; tremor quantification, shuffle detection, and/or other suitable gait or biomechanical metrics.

Cadence can be characterized as the step rate of the participant.

Ground contact time is a measure of how long a foot is in contact with the ground during a step. The ground contact time can be a time duration, a percent or ratio of ground contact compared to the step duration, a comparison of right and left ground contact time (e.g., a variation of an asymmetry metric) and/or any suitable characterization.

Braking or the intra-step change in forward velocity is the change in the deceleration in the direction of motion that occurs on ground contact. In one variation, braking is characterized as the difference between the minimum velocity and maximum velocity within a step, or the difference between the minimum velocity and the average velocity within a step. Braking can alternatively be characterized as the difference between the minimal velocity point and the average difference between the maximum and minimum velocity. A step impact signal may be a characterization of the timing and/or properties relating to the dynamics of a foot contacting the ground.

Upper body trunk lean is a characterization of the amount a user leans forward, backward, left or right when walking, running, sitting, standing, or during any suitable activity. More generally, upper body posture could be measured or classified in a number of ways.

Step duration is the amount of time to take one step. Stride duration could similarly be used, wherein a stride includes two consecutive steps.

Step length is the forward displacement of each foot. Stride length is the forward displacement of two consecutive steps of the right and left foot.

Swing time is the amount of time each foot is in the air. Ground contact time is the amount of time the foot is in contact with the ground.

Step impact is the measure of the force or intensity of contact with the ground in a vertical direction during ground contact. It could be measured as a force, a deceleration rate, or other similar metric.

Activity transition time preferably characterizes the time between different activities such as lying down, sitting, standing, walking, and the like. A sit-to-stand transition is the amount of time it takes to transition from a sitting state to a standing state.

Left and right step detection can function to detect individual steps. Any of the biomechanical measurements could additionally be characterized for left and right sides. Right and left step detection can be performed even for sensor positions like pelvic region where the sensor is not on a particular side. An activity sensor positioned on one side may collect metrics for only one side or for both. For example, a pelvic-positioned sensor may track right and left biomechanical signals, where a right-foot-positioned sensor may track at least a subset of biomechanical signals for only the right foot.

Stride asymmetry can be a measure of imbalances between different steps. It quantifies the difference between left-side gait mechanics and right-side gait mechanics. Strides or bouts of strides can be identified as symmetrical or asymmetric for each relevant gait component. The asymmetric components could be aggregated overtime wherein asymmetry patterns of a stride that were exhibited over an extended duration could be reported. Temporary non-consistent asymmetries in a stride may be left as unreported since they may be normal responses to the environment. Asymmetric gait dynamics preferably describe asymmetries between right and left steps. It can account for various factors such as stride length, step duration, pelvic rotation, pelvic drop, ground contact time, and/or other factors. In one implementation, it can be characterized as a ratio or side bias where zero may represent balanced symmetry and a negative value or a positive value may represent left and right biases respectively. Symmetry could additionally be measured for different activities such as posture asymmetry (degree of leaning to one or another side) when standing.

For step length asymmetries, detecting segments of the sensor data with asymmetric gait dynamics comprises detecting right and left step lengths and comparing the right step length(s) and left step length(s). The comparison, which can be the difference between the lengths (or some average of lengths), or ratio of lengths (or average lengths) may be used as the measure of asymmetry. For example, a value near zero indicates step lengths are similar or the same in length and a large value indicates a larger discrepancy. In another example, a ratio close to 1 is symmetrical, whereas values greater than or less than 1 (such as 1.2) may indicate asymmetry. The comparison can be normalized for user height and/or the step length of the greater length or to the specified foot (e.g., a right foot). In one variation, the asymmetric step length conditions could be classified when the comparison satisfies some condition (e.g., being greater than a step length difference or ratio threshold). Significant step length asymmetries may be indicators of a limp, dragging of a leg, localized pain/weakness in a leg, or other symptoms. Different conditions based on stride asymmetry can be used to determine when to deliver feedback or initiate another response. Sudden changes in stride asymmetry in particular can be a condition used to trigger an alert.

For step time differences, detecting segments of the sensor data with asymmetric gait dynamics can be substantially similar to step lengths except that the step time for left and right steps can be compared.

Stride speed can be computed by taking stride length and dividing by the total amount of time between strides. Stride speed could additionally be measured for each leg such that there could be a right and left stride speed metric.

For pelvic tilt or posture asymmetries, detecting asymmetric gait dynamics can include detecting orientation states during a right step and orientation states during a left step and comparing the right and left orientation states. Here orientation states can include pelvic dynamics (e.g., how they lean over the hip).

Pelvic dynamics can be represented in several different biomechanical signals including pelvic rotation, pelvic tilt, and pelvic drop. Pelvic rotation (i.e., yaw) can characterize the rotation in the transverse plane (i.e., rotation about a vertical axis). Pelvic tilt (i.e., pitch) can be characterized as rotation in the sagittal plane (i.e., rotation about a lateral axis). Pelvic drop (i.e., roll) can be characterized as rotation in the coronal plane (i.e., rotation about the forward-backward axis).

Vertical oscillation of the pelvis is characterization of the up and down bounce during a step (e.g., the bounce of a step).

Lateral oscillation of the pelvis is the characterization of the side-to-side displacement during a stride possibly represented as a lateral displacement.

The motion path can be a position over time map for at least one point. Participants will generally have movement patterns that are unique and generally consistent between activities with similar conditions.

Balance can be a measure of posture or motion stability when walking, running, standing, carrying, or performing any suitable activity.

Turn speed can characterize properties relating to turns by a user. In one variation, turn speed can be the amount of time to turn. Additionally or alternatively turn speed can be characterized by peak velocity of turn, and/or average velocity of turn when a user makes a turn in their gait cycle.

Foot pronation could be a characterization of the angle of a foot during a stride or at some point of a stride. Similarly foot contact angle can be the amount of rotation in the foot on ground contact. Foot impact is the upward deceleration that is experienced occurring during ground contact. The body-loading ratio can be used in classifying heel, midfoot, and forefoot strikers. The foot lift can be the vertical displacement of each foot. The motion path can be a position over time map for at least one point of the user's body. The position is preferably measured relative to the user. The position can be measured in one, two, or three dimensions. As a feature, the motion path can be characterized by different parameters such as consistency, range of motion in various directions, and other suitable properties. In another variation, a motion path can be compared based on its shape.

The foot lift can be the vertical displacement of each foot.

Neck tilt can be the posture or orientation of the head. Neck orientation can include neck/head tilt (i.e., pitch—rotation in the sagittal plan), neck/head roll (i.e., rotation about the forward-backward axis), and head neck rotation (i.e., yaw—rotation in the transverse plane/rotation about a vertical axis).

Double-stance time is the amount of time both feet are simultaneously on the ground during a walking gait cycle. Detecting segments of sensor data indicative of double stance gait patterns can include detecting a double stance condition in the ground contact time of the right and left steps. Double stance time is preferably detected and collected by detecting ground contact time for both feet and counting simultaneous foot contact time for the two feet. The duration of double stance time compared to the non-double stance time of a stride or step (i.e., double stance “duty cycle”) can be used as an indicator of poor mobility because the user is relying on keeping both feet on the ground. Users that are unstable on their feet may have a tendency to walk in a way that minimizes the amount of time they stand on one foot. Double stance time can also be represented by the ratio of an average double stance ground contact time to an average single stance ground contact time.

Shuffle detection can be a characterization of shuffling gait when moving. Shuffling may be a walking motion that lacks the vertical displacement of the feet when walking. In extreme cases this may be where a user doesn't lift their feet when walking and instead slides them across the floor. Accordingly, detecting segments of sensor data indicative of shuffling gait patterns can include detecting vertical step displacements of the right and/or left steps and classifying the gait as shuffling when vertical step displacements satisfy a shuffle condition. The shuffle detection may be based on vertical displacements that are below some step displacement threshold. The threshold and/or the measured vertical displacements can be normalized or otherwise adjusted to account for user height, age, and/or other factors. The shuffle condition may additionally look at vertical displacements over a particular time window. For example, an average vertical displacement of the past 1 minute of walking or average of the last 10 steps that is under the shuffle threshold may alternatively be a shuffle condition. The shuffle condition may also look at percentage of shuffling time for a stretch of walking. For example, walking short distances (e.g., when moving from point to point in the house) may be counted in one way while walking long distances (e.g., when walking long stretches of distance) may be counted another way. Individualized tracking and analysis for different types of walking paths can be performed for any suitable mobility metric.

Tremor quantification can include detecting tremors but can additionally be used in measuring duration, frequency response components, and magnitude of tremors. Detecting tremors preferably includes detecting vibrations or small vibrations within a certain frequency range and intensity range. In some cases, a tremor activity by a user may have a frequency response such as between 4 Hz and 10 Hz, which could be characterized by the frequency response components. Additionally, range of motion may also quantify the tremor magnitude. Tremor detection can be isolated to particular parts of a stride or motion.

Biomechanical signals or gait dynamics may be expressed as variability or consistency metrics. Biomechanics variability or consistency can characterize variability or consistency of a biomechanical property such as of the biomechanical measurements discussed herein. The cadence variability may be one exemplary type of biomechanical variability signal, but any suitable biomechanical property could be analyzed from a variability perspective. Cadence variability may represent some measure of the amount of variation in the steps of the wearer. In one example, the cadence variability is represented as a range of cadences. The cadence variability may be used for interpreting the variations in walking patterns

Measuring posture functions to generate a metric that reflects the nature of a user's posture and ergonomics. This is preferably performed when standing, walking, or running. Posture or position can additionally be used when sitting or lying down.

In one variation, measuring posture can be an offset measurement of the calibrated biomechanical sensing device orientation relative to a target posture orientation. A target posture orientation may be pre-configured. For example, an activity monitoring system with a substantially consistent orientation when used by a user may have a preconfigured target posture orientation. Alternatively, a target posture orientation may be calibrated during use automatically. Target posture orientation may be calibrated automatically upon detecting a calibration state. A calibration state may be pre-trained kinematic data patterns that signal some understood orientation. For example, sitting down or standing up may act as a calibration state from which calibration can be performed. A target posture orientation may alternatively be manually set. For example, a user may position their body in a desired posture orientation and select an option to set the current orientation as a target orientation. In another variation, the target orientation may change depending on the current activity. Accordingly, measuring posture can include detecting a current activity through the kinematic data (or other sources), selecting a current target posture orientation for the current activity and measuring orientation relative to the current target posture orientation.

In one variation, measuring posture may include characterizing posture. Characterizing posture may not generate a distinct measurement, and instead classifies different kinematic states in terms of posture descriptors such as great posture, good posture, bad posture, and dangerous posture. Various heuristics and/or machine learning may be applied in defining classifications and detecting gesture classifications.

Additionally activating a kinematic monitoring mode may activate additional system functionality associated with a particular mode. Various monitoring modes may have different forms of user feedback, data event triggering, data logging, and the like. Gait monitoring modes may include logging of data. Running related modes may include delivering active user feedback; delivering coaching for running related goals; mapping of a run; logging of run metrics like time distance and speed; and/or other run related actions. Posture related modes might include tracking posture quality, comparing posture state to a target posture state, and delivering posture feedback. Each one of these modes may use different sampling frequencies, filters and sensor fusion parameters. In addition, each activity monitoring mode may segment the data differently, compute different biomechanical signals, and/or monitor the user for different lengths of time.

For example, a walking gait monitoring mode for a pelvis-position may measure the pelvis dynamics such as pelvic rotation, drop and tilt. A walking gait monitoring mode for a clavicle-position may measure the average posture and vertical oscillation of the core. A walking gait monitoring mode for a foot-position may measure the step impact magnitude, cadence, step length, and ground contact time. All these monitoring modes measure walking gait but provide different biomechanical signals to help characterize the user's walking gait. The same can be generalized to other activities such as running and biking.

Furthermore, a sensor can operate in multiple types of kinematic monitoring modes. For example, there could be multiple types of walking monitoring modes. The sensor can operate in a clinical monitoring mode that measures specific pelvic dynamics with a specific sampling frequency, resolution and time period. The sensor can also operate a walking monitoring mode specific to particular walking gait issue such as fall risk prevention. In a pelvis-positioned walking monitoring mode for fall risk, the sensor may specifically measure the biomechanical signals known to be correlated with fall risk such as balance, pelvic dynamics, cadence variability, gait asymmetries, and gait speed. In a foot-positioned fall risk monitoring mode, the sensor may measure step length, step length variability, stride speed, swing variability and double stance time. In another example, a different foot-positioned walking gait monitoring mode can focus on steps and cadence.

Similarly, the sensor can operate in multiple running monitoring modes or other activities. The sensor can be switched to a running mode to measure or provide feedback and coaching for sprinters, middle distance runners or long distance runners. In addition to different modes potentially measuring different biomechanical signals, the sensor mode may also be optimized for different sampling frequencies, filters, sensor fusion parameters and battery conservation.

In one variation, the user, a physician, care provider, coach, or other suitable entity may customize a monitoring mode by selecting the biomechanical signals that are most relevant to measure. For example, a user within a user application could specify the type of walking monitoring mode, running monitoring mode, and/or posture monitoring mode that they want to use when those activities are detected. Monitoring modes can be saved in the sensor, peripheral computing device or cloud database and used to compare against other users or groups with similar monitoring modes.

The method as described herein primarily describes the configuration of a monitoring mode at one instance. The method may additionally support automatically updating for changes in sensor location and/or activity.

In one variation, the configuration process may be periodically or continuously repeated to assess sensor location and activity status. In the case of continuously polling configuration, the mode changes are preferably averaged, smoothed, or apply some form of hysteresis to avoid erroneous mode changes from data anomalies. For example, modes may only be changed if the location and/or activity status is detected as changed for some minimum duration of time.

In another variation, the configuration process may be triggered by some detectable event. For example, shaking the sensor or tapping it in a particular pattern may be used to reconfigure the sensors for a new location or activity.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A method for activity monitoring comprising:
collecting kinematic data from at least one kinematic activity sensor coupled to a user;
generating a set of base kinematic metrics;
assessing a set of sensor state discriminators and identifying a kinematic monitoring mode; and
activating the kinematic monitoring mode at the at least one kinematic activity sensor.

2. The method of claim 1, wherein identifying a kinematic monitoring mode comprises determining position of an activity sensor, wherein the identified kinematic monitoring mode is associated to the determined position.

3. The method of claim 2, wherein assessing the set of sensor state discriminators comprises assessing at least a first regional discriminator to select one of a set of location candidates.

4. The method of claim 2, wherein assessing the set of sensor state discriminators further comprises assessing a secondary regional discriminator.

5. The method of claim 2, wherein assessing the set of sensor state discriminators further comprises assessing an activity discriminator for at least one of the location candidates.

6. The method of claim 2, wherein, if a first location candidate is selected, further assessing a right-left discriminator and identifying a right or left location-specific kinematic monitoring mode

7. The method of claim 1, wherein activating the kinematic monitoring mode at the at least one kinematic activity sensor comprises generating a set of biomechanical signals through processing modules customized to the identified kinematic monitoring mode.

8. The method of claim 1, wherein activating the kinematic monitoring mode at the at least one kinematic activity sensor comprises: for a first kinematic monitoring mode generating a first set of biomechanical signals; for a second kinematic monitoring mode generating a second set of biomechanical signals; wherein the first set of biomechanical signals is different from the second set of biomechanical signals.

9. The method of claim 1, wherein collecting kinematic data from at least one kinematic activity sensor coupled to a user further comprises collecting kinematic data from a plurality sensors positioned at distinct locations of the user; wherein generating the base kinematic metrics comprises generating at least a first set of relative metrics, where a relative metric compares metrics from at least two activity sensors; and wherein identifying a kinematic monitoring mode comprises identifying a kinematic monitoring mode for each of the plurality of sensors.

10. The method of claim 9, wherein identifying a kinematic monitoring mode for each of the plurality of sensors further comprises selectively activating a kinematic monitoring mode of a first activity sensor based in part on the kinematic monitoring mode of at least a second activity sensor.

11. The method of claim 1, wherein identifying a kinematic monitoring mode comprises selecting a kinematic monitoring mode selected from a set of kinematic monitoring modes that comprises at least a walking gait monitoring mode, a posture monitoring mode, and a running monitoring mode.

12. The method of claim 11, wherein the set of kinematic monitoring modes further comprises an exercise training monitoring mode and a neck posture monitoring mode.

13. The method of claim 1, wherein identifying a kinematic monitoring mode comprises selecting a kinematic monitoring mode selected from a set of kinematic monitoring modes that comprises at least a foot-positioned monitoring mode, a pelvic-positioned monitoring mode, and an upper-body-positioned monitoring mode.

14. The method of claim 1, wherein identifying a kinematic monitoring mode comprises selecting a kinematic monitoring mode selected from a set of kinematic monitoring modes that comprises at least a foot-positioned walking gait monitoring mode, a pelvic-positioned walking gait monitoring mode, a pelvic-positioned posture monitoring mode, and an upper-body-positioned posture monitoring mode.

15. The method of claim 1, wherein the set of base kinematic metrics includes step impact magnitude; wherein assessing a set of sensor state discriminators and identifying a kinematic monitoring mode comprises:
for a first regional discriminator, checking for step impact magnitude greater than 4 G's and determining a foot position if the condition is valid or a non-foot position if the value is not valid; and
identifying a foot-positioned monitoring mode if the first regional discriminator determines a foot position.

16. The method of claim 15, wherein the set of base kinematic metrics includes average peak rotation rate wherein assessing a set of sensor state discriminators and identifying a kinematic monitoring mode further comprises:
for a second regional discriminator assessed upon detecting the non-foot position, checking if the average peak rotation rate around a vertical axis is greater than an angular velocity threshold and determining a pelvis position if valid and a chest position if not valid;
identifying a pelvis-positioned monitoring mode if the second regional discriminator determines a pelvis position; and
identifying a chest-positioned monitoring mode if the second regional discriminator determines a chest position.

17. The method of claim 1, wherein at least one of the sensor state discriminators is a machine learning model.

18. The method of claim 17, wherein the machine learning model is trained on labeled data of the user.

19. The method of claim 1, further comprising detecting a change in the activity and updating the kinematic monitoring mode at the kinematic activity sensor.
